(19) United States
(12) Patent Application Publication
(10) Pub. No.: US 2025/0121763 A1
(43) Pub. Date: Apr. 17, 2025

(54) SYSTEM AND METHOD FOR TRANSPORTATION AND STORAGE OF RAILCARS

(71) Applicant: Kyle Pattison, Prairie du Chien, WI (US)

(72) Inventor: Kyle Pattison, Prairie du Chien, WI (US)

(21) Appl. No.: 18/912,956

(22) Filed: Oct. 11, 2024

Related U.S. Application Data
(60) Provisional application No. 63/590,660, filed on Oct. 16, 2023.

(51) Int. Cl. B60P 3/06; B60P 1/18

(52) U.S. Cl. CPC B60P 3/068; B60P 1/18

(57) ABSTRACT

In one or more arrangements, a system is presented for transportation of a railcar. The system also includes a trailer having a flatbed configured to move between a tilted position and a horizontal position. The flatbed has a track assembly that when the flatbed is tilted and the track assembly is aligned with a set of rail tracks, a railcar may be loaded by rolling the railcar from the rail tracks onto the track assembly of the flatbed. The system also includes an alignment device operably connected to the flatbed and configured to automatically align the track assembly of the flatbed with the set of rail tracks as the flatbed is tilted downward towards the track.

### CROSS REFERENCE TO RELATED APPLICATION

This application claims priority U.S. Provisional Application No. 63/590,660 filed Oct. 16, 2023, and titled “SYSTEM AND METHOD FOR TRANSPORTATION AND STORAGE OF RAILCARS”, which is hereby incorporated by reference in its entirety.

### FIELD OF THE DISCLOSURE

This disclosure generally relates to railcars. More specifically and without limitation, this disclosure relates to railcar transportation and storage.

### OVERVIEW OF THE DISCLOSURE

Railcar storage poses a challenge for industries that ship goods by rail. Like all industries, demand and supply for particular goods varies over time, for example, due to seasonal need, shortages, strikes, or other economic and/or logistic challenges. However, when railcars are not utilized for shipping of goods, railcars must be stored until they are ready for use. In some industries, it may additionally or alternatively make sense for loaded railcars to be placed into storage (e.g., if the loaded railcar is not scheduled to be shipped until a later date).

Traditionally, railcars are stored in facilities (e.g., railyards) having rail infrastructure permitting railcars to be moved in and out by rail as needed. Railcar storage in this manner can be quite expensive and makes it difficult to efficiently store cars while permitting particular railcars to be accessed and move out on demand. For instance, to facilitate flexible redirection of railcars, a complex system of rail switches are required, which are expensive and require regular maintenance. Moreover, such storage facilities generally need to be located near existing rail infrastructure to facilitate transportation.

Therefore, for all the reasons stated above, and all the reasons stated below, there is a need in the art for an improved mounting system for transportation and storage of railcars.

Thus, it is a primary object of the disclosure to provide a system for transportation and storage of railcars that improves upon the state of the art.

Another object of the disclosure is to provide a system for transportation and storage of railcars that assists in the loading and transportation of railcars between rail systems.

Yet another object of the disclosure is to provide a system for transportation and storage of railcars that assists in the loading and transportation of railcars by truck.

Another objective of the disclosures is to provide a system of storing cars on tracks that are not FRA certified and do not have switches joining them.

Yet another object of the disclosure is to provide a system for transportation and storage of railcars that is affordable.

Another object of the disclosure is to a system for transportation and storage of railcars that is easy to use.

Yet another object of the disclosure is to provide a system for transportation and storage of railcars that can relocate railcars to remote storage facilities.

Another object of the disclosure is to provide a system for transportation and storage of railcars that is robust.

Yet another object of the disclosure is to provide a system for transportation and storage of railcars that is durable.

Another object of the disclosure is to a system for transportation and storage of railcars that has a long useful life.

Yet another object of the disclosure is to provide a system for transportation and storage of railcars that works effectively.

Another object of the disclosure is to provide a system for transportation and storage of railcars that is high quality.

Yet another object of the disclosure is to provide a system for transportation and storage of railcars that is efficient.

These and other objects, features, or advantages of the disclosure will become apparent from the specification, figures and claims.

### SUMMARY

In one or more arrangements, a system is presented for transportation of a railcar. The system also includes a trailer having a flatbed configured to move between a tilted position and a horizontal position. The flatbed has a track assembly that when the flatbed is tilted and the track assembly is aligned with a set of rail tracks, a railcar may be loaded by rolling the railcar from the rail tracks onto the track assembly of the flatbed. The system also includes an alignment device operably connected to the flatbed and configured to automatically align the track assembly of the flatbed with the set of rail tracks as the flatbed is tilted downward towards the track.

### BRIEF DESCRIPTION OF THE DRAWINGS

FIG. 1 shows a side view of a system for transportation and/or storage of railcars, in accordance with one or more arrangements.

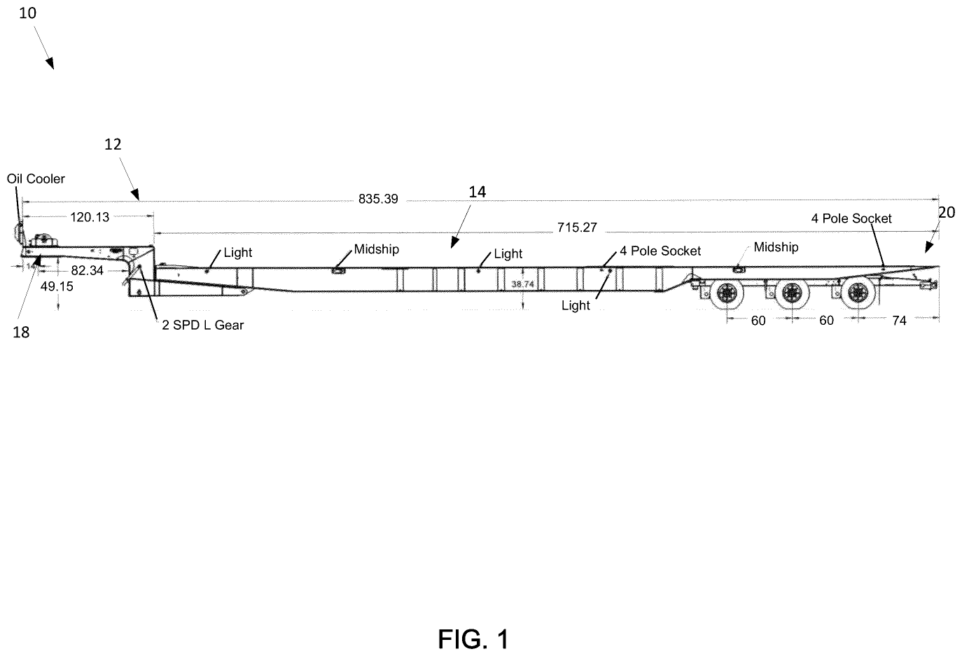

FIG. 2 shows a top view of a system for transportation and/or storage of railcars, in accordance with one or more arrangements.

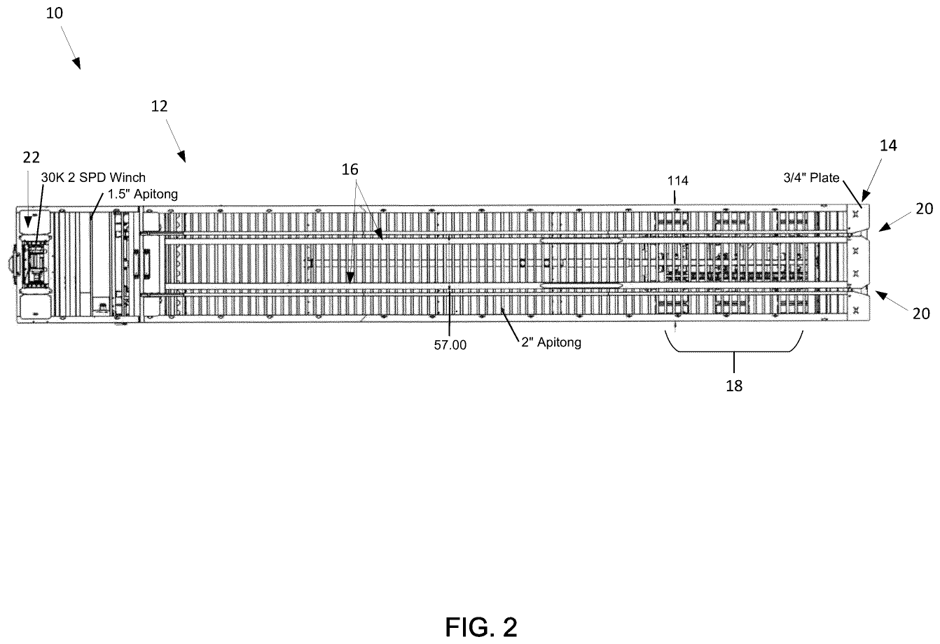

FIG. 3 shows a side view of a system for transportation and/or storage of railcars, in accordance with one or more arrangements; the view showing a flatbed of the system in a tilted lowered position.

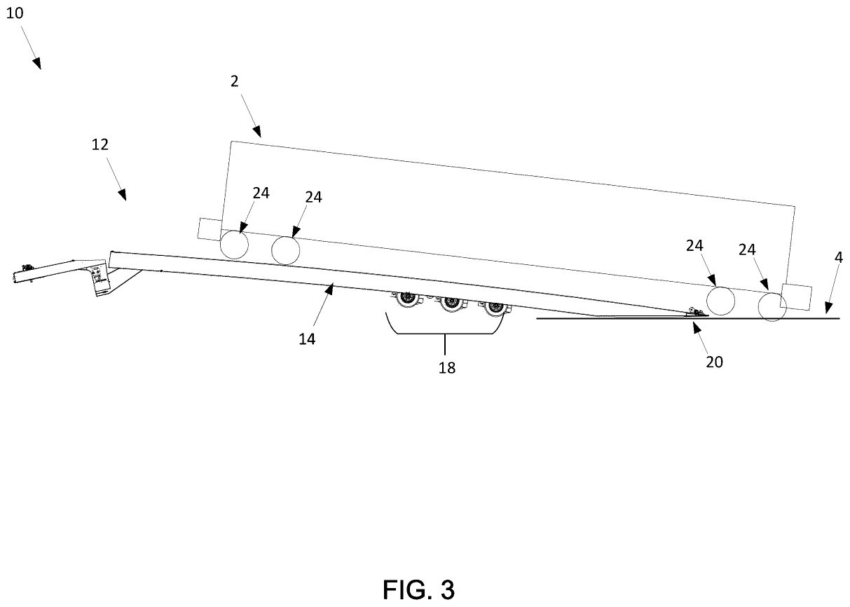

FIG. 4 shows a side view of a system for transportation and/or storage of railcars, in accordance with one or more arrangements; the view showing a flatbed of the system in a raised horizontal position; the view showing a railcar loaded onto the flatbed.

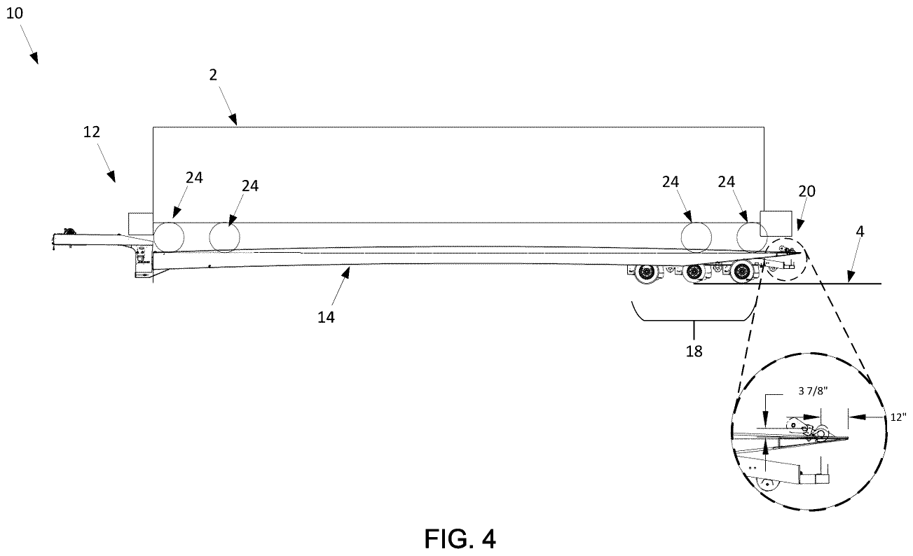

FIG. 5 shows an image of a railcar being loaded onto a system for transportation and/or storage of railcars, in accordance with one or more arrangements.

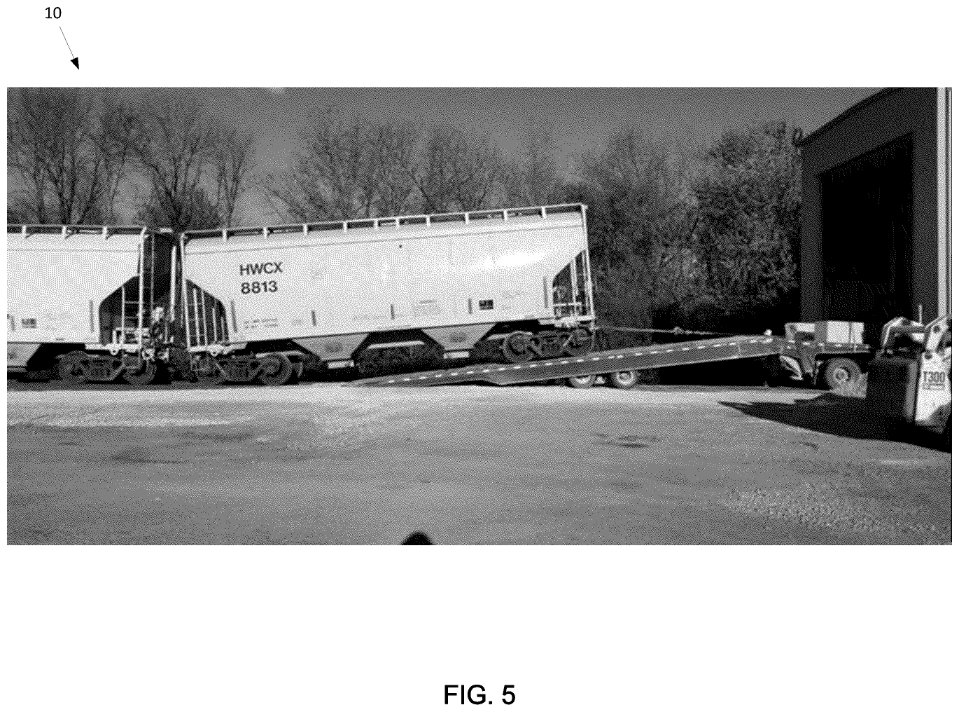

FIG. 6 shows a close up view of a railcar being loaded onto a system for transportation and/or storage of railcars, in accordance with one or more arrangements.

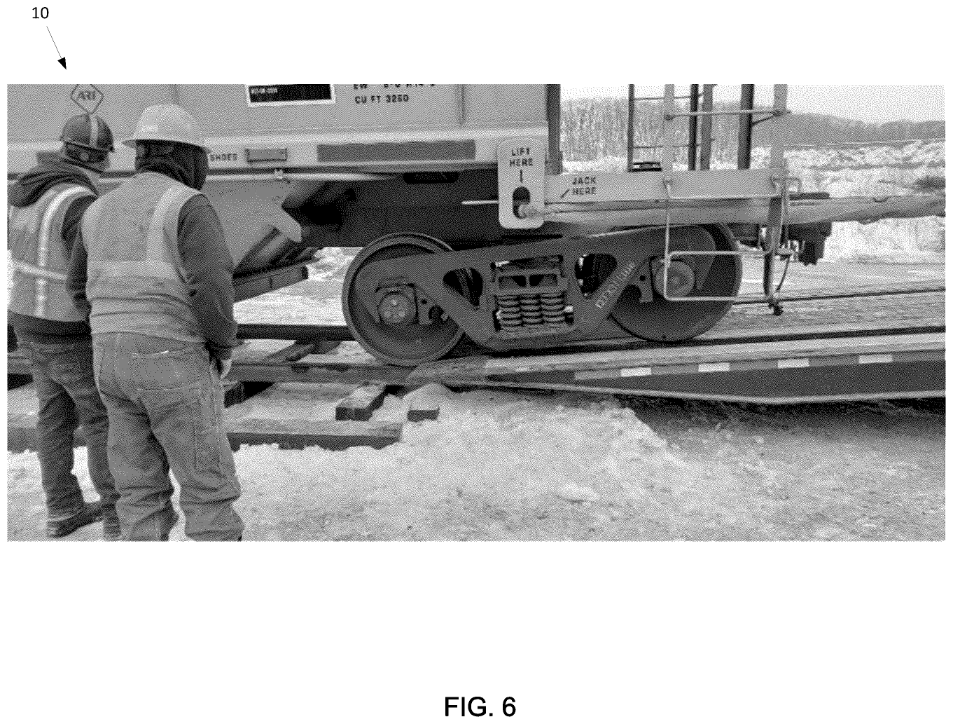

FIG. 7 shows an image of a railcar loaded onto a system for transportation and/or storage of railcars, in accordance with one or more arrangements; the view showing the railcar being moved from FRA approved tracks to other tracks.

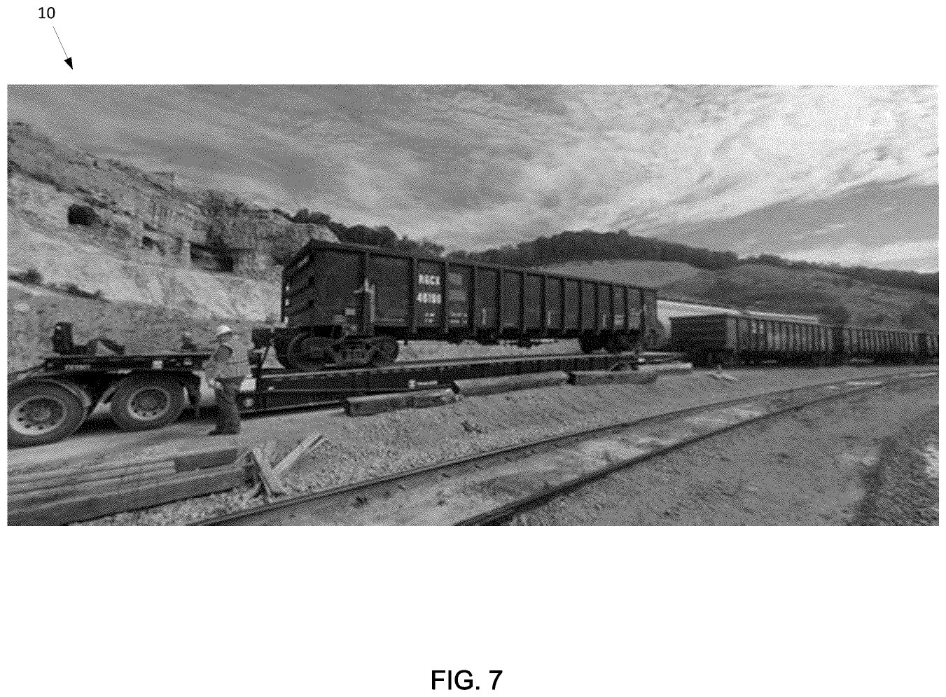

FIG. 8 shows an image of a railcar loaded onto a system for transportation and/or storage of railcars, in accordance with one or more arrangements.

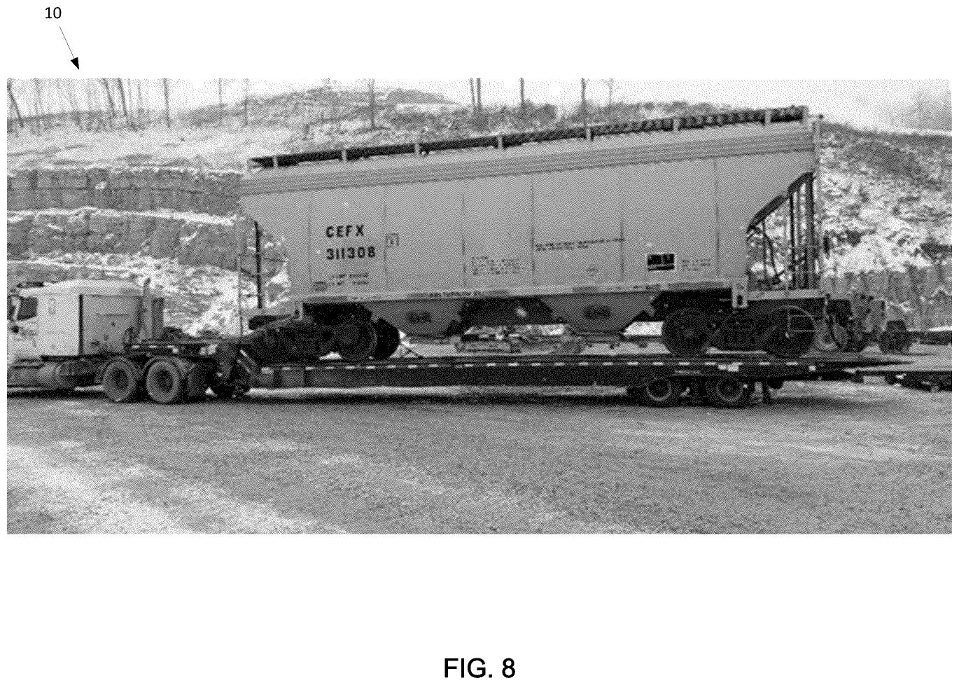

FIG. 9 shows a close up image of a winch system for use with a system for transportation and/or storage of railcars, in accordance with one or more arrangements; wherein the winch system is configured to pull railcars off trailer when they will not roll off on their own.

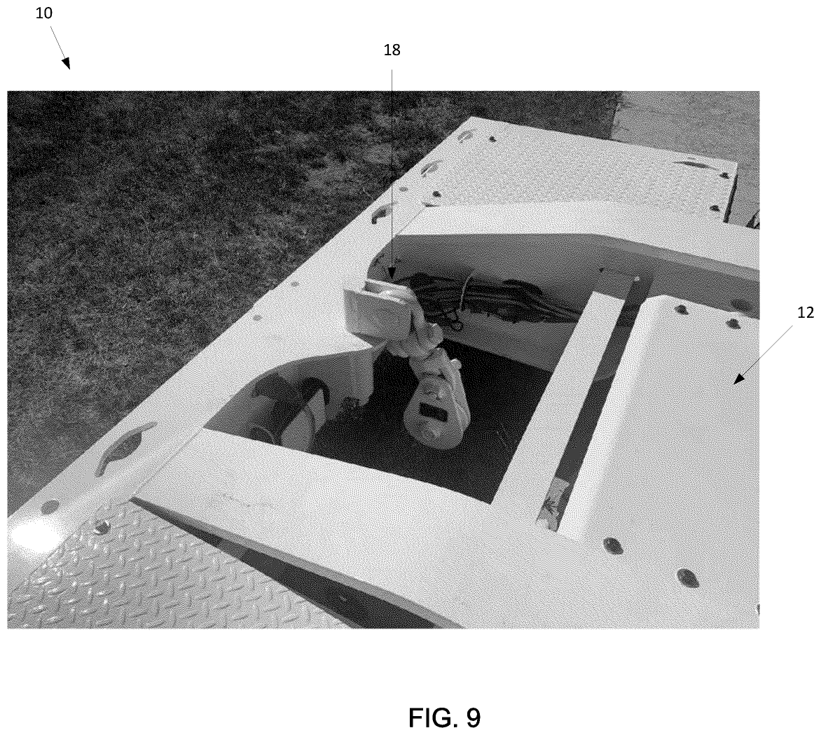

FIG. 10 shows a close up image of an alignment device for a system for transportation and/or storage of railcars, in accordance with one or more arrangements.

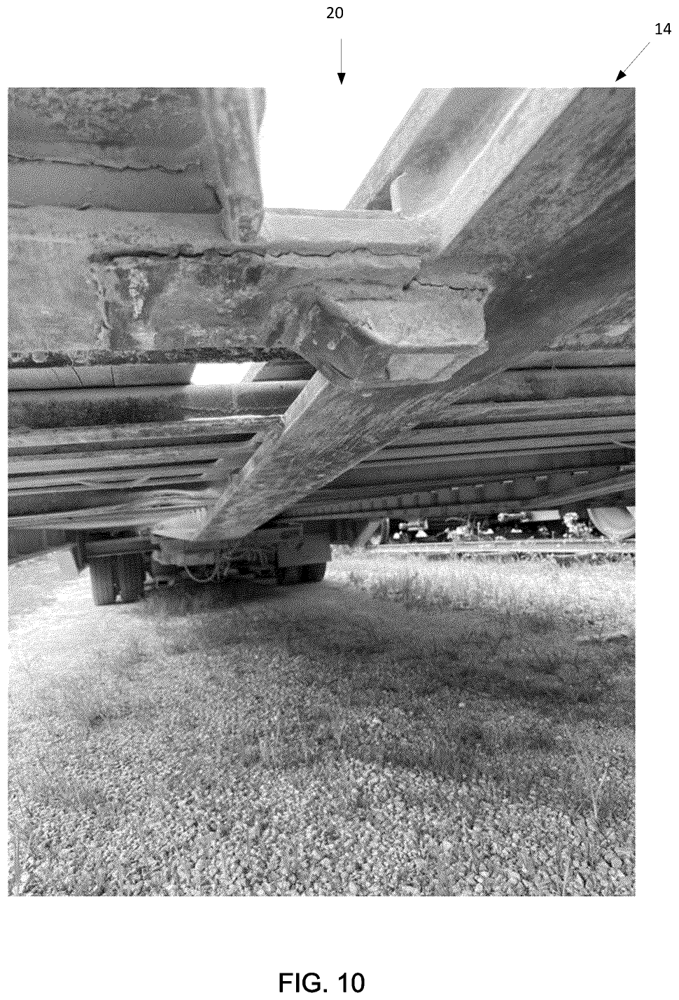

FIG. 11 shows a close up image of an alignment device for a system for transportation and/or storage of railcars, in accordance with one or more arrangements.

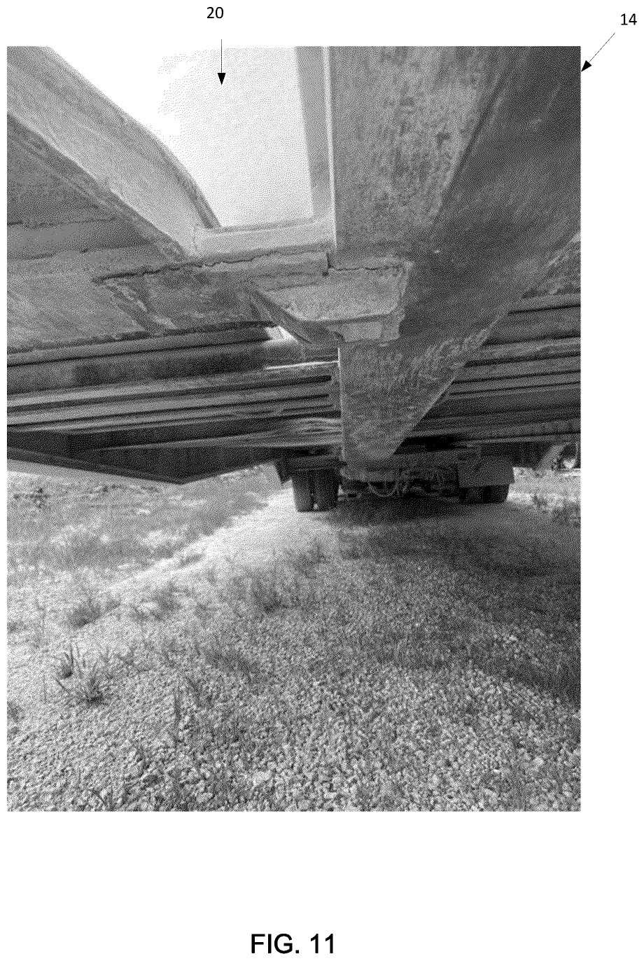

FIG. 12 shows a close up image of an alignment device for a system for transportation and/or storage of railcars, in accordance with one or more arrangements.

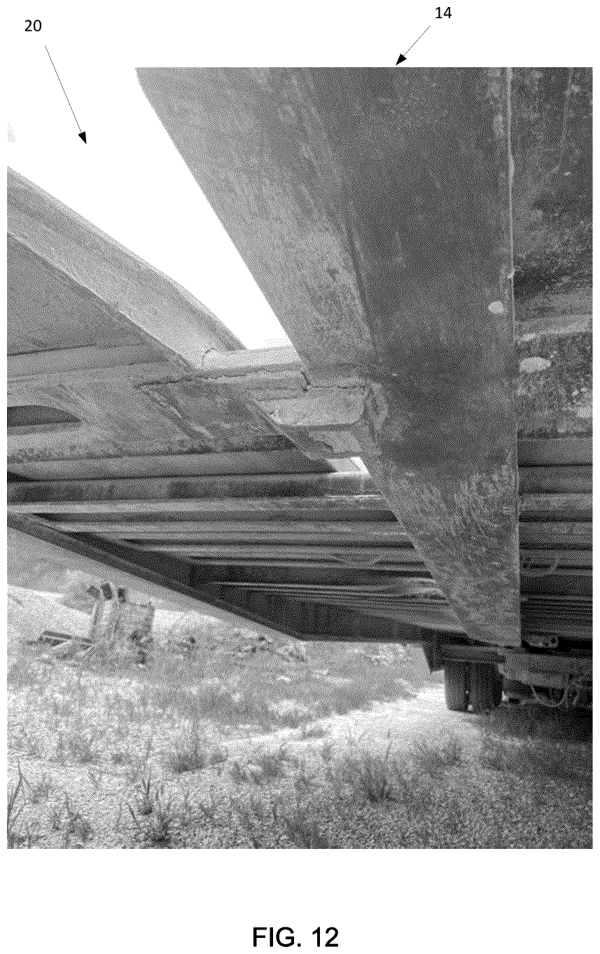

FIG. 13 shows a close up side view image of an alignment device for a system for transportation and/or storage of railcars, in accordance with one or more arrangements.

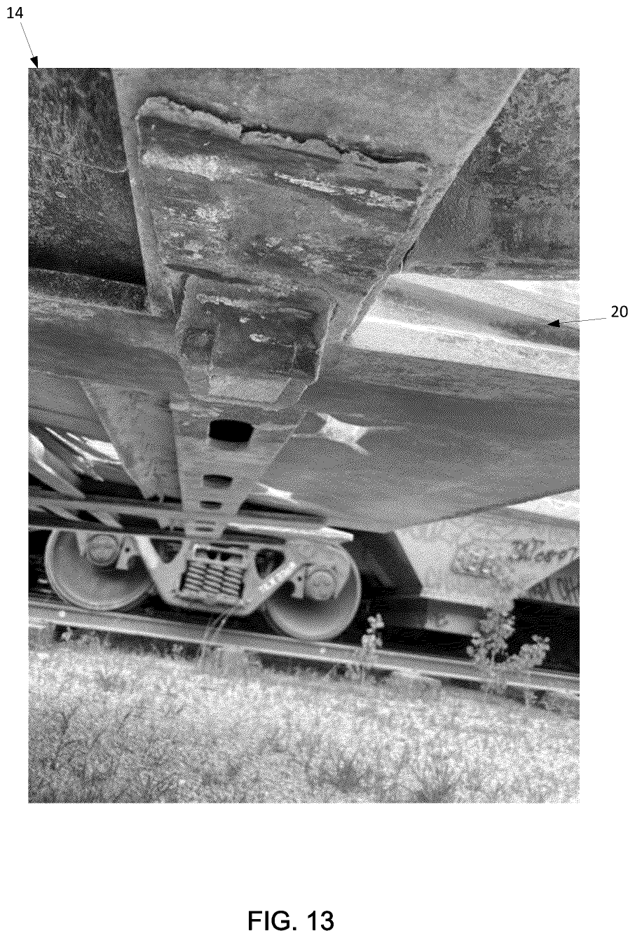

FIG. 14 shows an image of a railcar that has been moved to an isolated track segment for storage, in accordance with one or more arrangements.

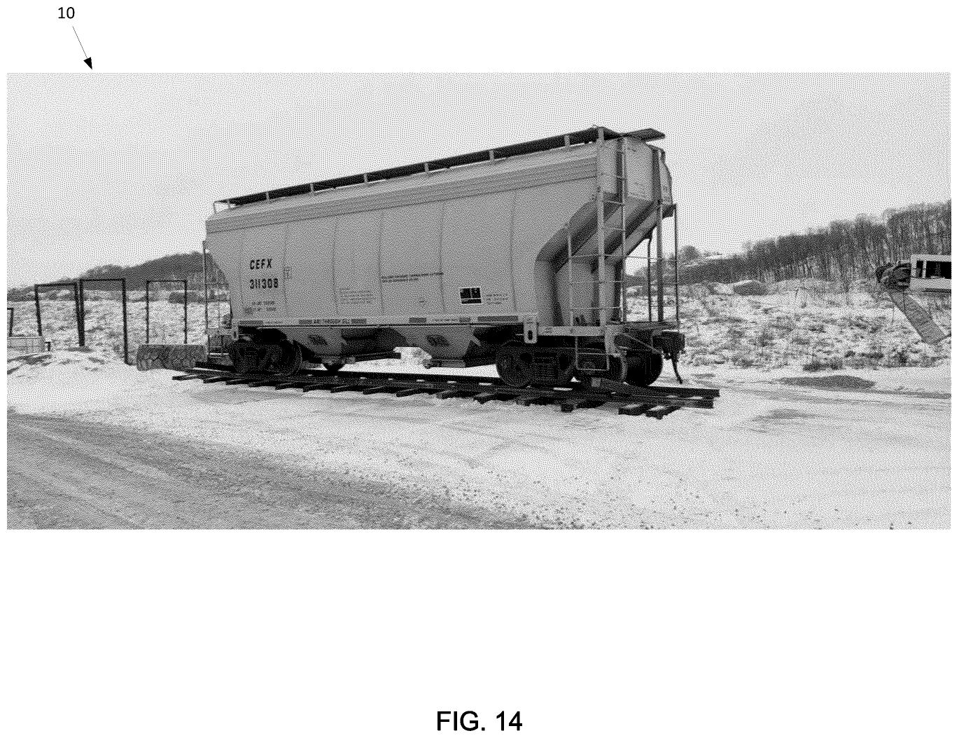

FIG. 15 shows an image of a railcar loaded onto a system for transportation and/or storage of railcars, in accordance with one or more arrangements.

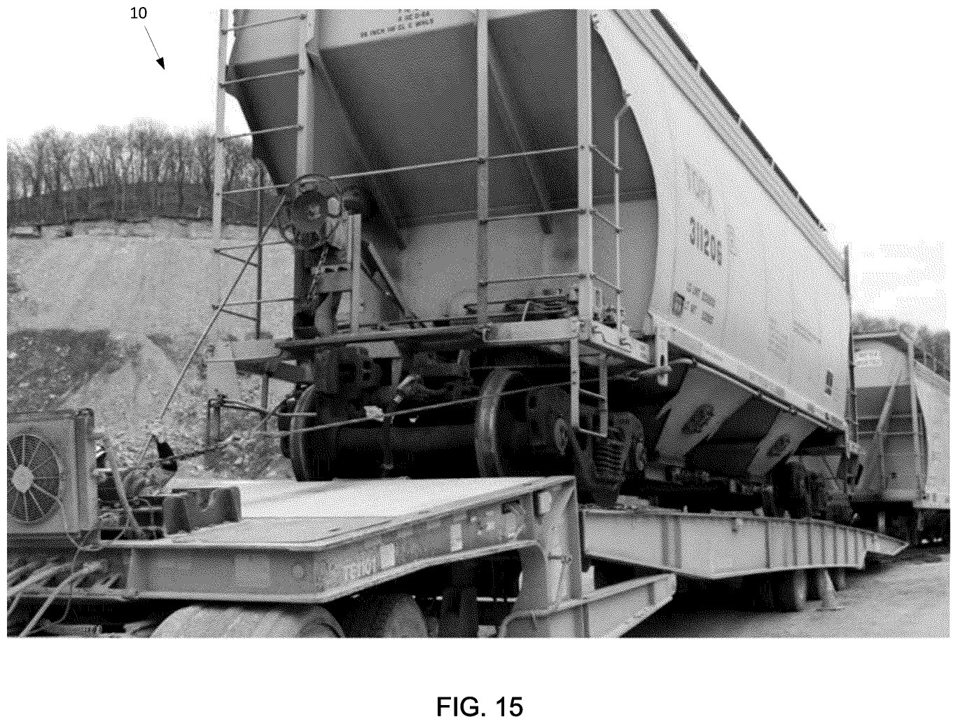

FIG. 16 shows a diagram for a hydraulic flow system for use with a system for transportation and/or storage of railcars, in accordance with one or more arrangements; the diagram showing an improved hydraulic flow system configured to speed up car movements and also to keep oil cool, in accordance with one or more arrangements.

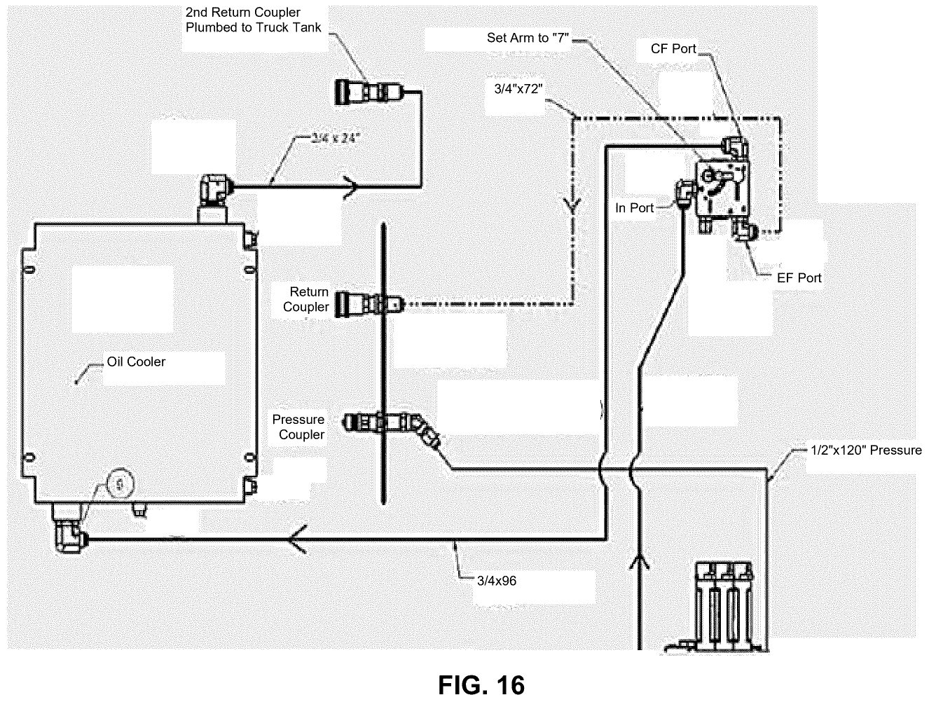

FIG. 17 shows a diagram for a control system for use with a system for transportation and/or storage of railcars, in accordance with one or more arrangements.

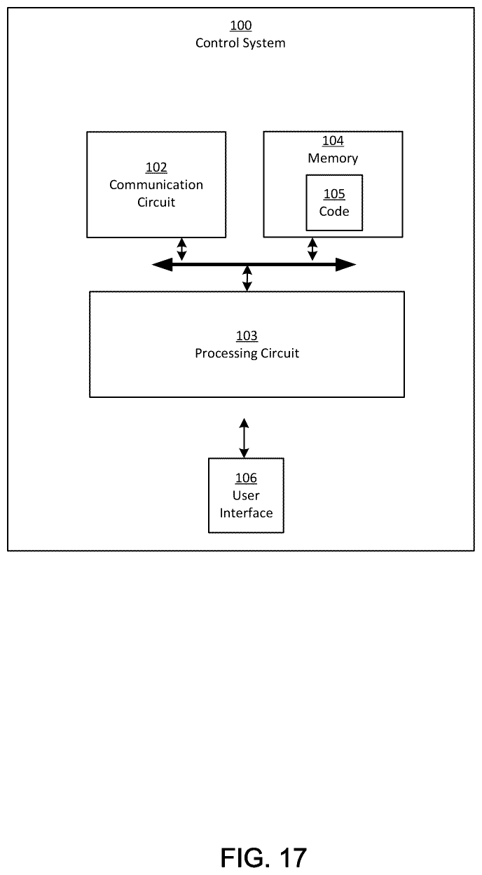

FIG. 18 illustrates an overview of railcar storage and some benefits that may be provided the disclosed systems and/or methods.

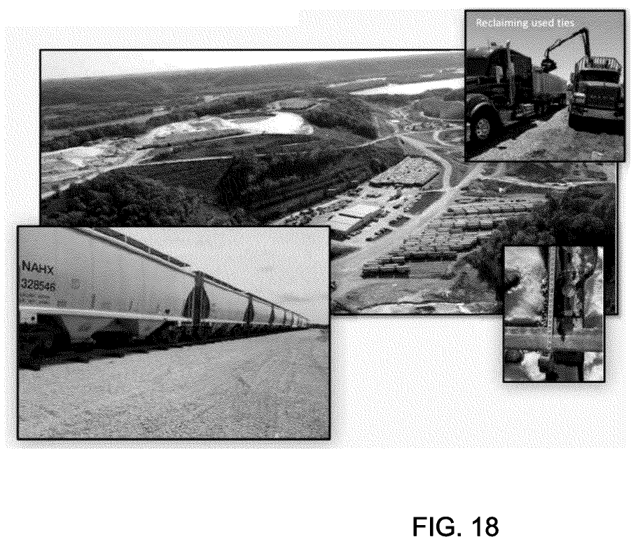

FIG. 19 illustrates an overview of railcar storage and some benefits that may be provided the disclosed systems and/or methods.

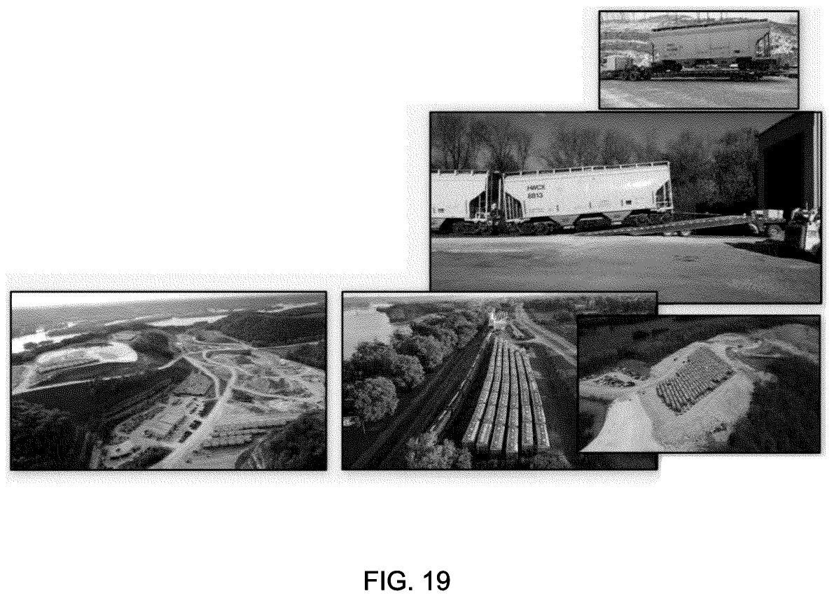

FIG. 20 shows images of examples of railcar storage and/or the disclosed systems and/or methods in use.

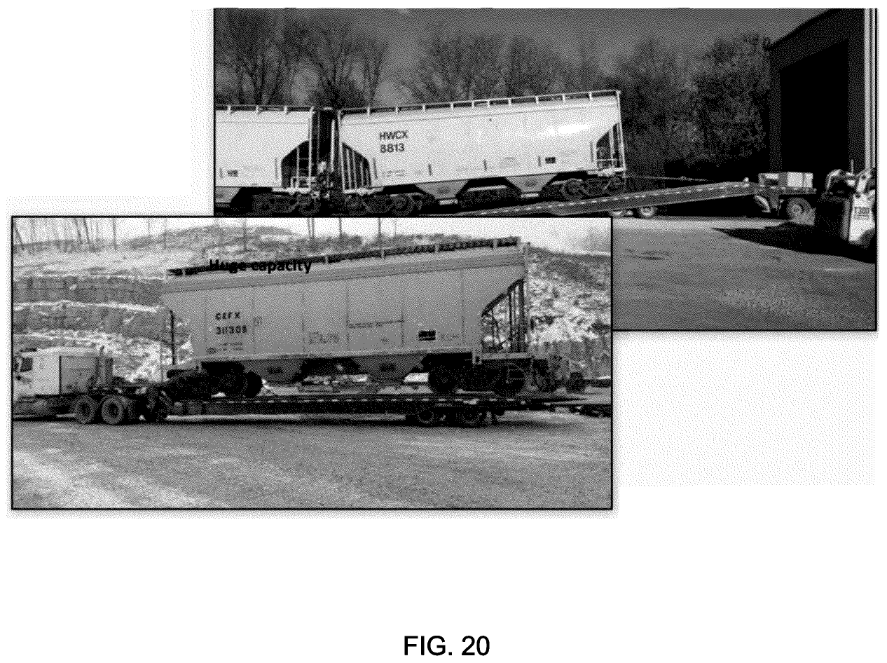

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of railcars. However, the embodiments are not so limited. It is appreciated that the embodiments may be adapted for use in other applications which may be improved by the disclosed structures, arrangements and/or methods. The system is merely shown and described as being used in the context of railcars for ease of description and as one of countless example applications.

Turning now to the figures, a system and method for transportation and storage of railcars is presented, as is shown as one example.

### System 10

With reference to the figures, a system for transportation and/or storage of railcars 10 is presented (or simply system 10). In the arrangements shown, as some non-limiting examples, system 10 is configured to facilitate loading and unloading of railcars 2 from/to rail tracks and transportation of loaded railcars 2 via automotive transportation (e.g., by semitrucks).

In one or more arrangements, system 10 includes a trailer 12 having a tiltable flatbed 14. In one or more arrangements, the tiltable flatbed 14 has a track assembly 16 that when the flatbed is tilted and the track assembly 16 is aligned with a set of rail tracks 4, a railcar 2 may be loaded by rolling the railcar 2 from the rail tracks 4 onto the track assembly 16 of the flatbed 14.

In one or more arrangements, the system 10 includes an alignment device 20 operably connected to the tiltable flatbed 14 mounted on a wheel assembly 18. The alignment device 20 is formed of any suitable, size, shape and design and is configured to automatically align the track assembly 16 of the flatbed 14 with the set of rail tracks 4 as the flatbed 14 is tilted downward towards the track 4. In an arrangement shown, as one example, the alignment device 20 has two opposing sidewalls positioned in an angled wedge shape below the flatbed 14 proximate to the edge of the flatbed 14 that is configured to contact the rail tracks as the flatbed 14 is tilted downward. Once alignment device 20 contacts a rail track 4, alignment device 20 is configured to direct the flatbed into alignment as the flatbed 14 continues to be tilted downward toward the rail tracks 4. In one or more arrangements, the alignment device 20 may additionally or alternatively aid to hold system 10 in an aligned position to prevent shifting of the system as a railcar 2 is being loaded and/or unloaded. However, the arrangements are not so limited. Rather, it is contemplated that in some various arrangements, the alignment device 20 of system 10 may be configured to utilize various additional or alternative methods and/or means for alignment.

In one or more arrangements, system 10 includes a winch system 22 configured to facilitate pulling of the railcar 2 onto the track assembly 16 of the tilted flatbed 14 and/or pulling of the railcar 2 off of track assembly 16. In one or more arrangements, system 10 includes a multi-speed winch to permits railcars 2 to be loaded/unloaded more quickly while also permitting slower movement to accommodate transition of wheels between rail track 4 and track assembly 16 of system 10.

However, the arrangements are not so limited. Rather, it is contemplated that in some various arrangements, system 10 may be configured to use various different means and/or methods to facilitate loading of a railcar 2 onto the track assembly of the tilted flatbed 14 including but not limited to, for example (winches, pulleys, jacks, hydraulics, and/or any other method or means suitable to push, pull and/or otherwise move railcars 2 onto or off of the flatbed. Additionally or alternatively, in some arrangements, system 10 may utilize a winch, pully, or other means and/or methods for movement of railcar 2 to facilitate unloading of the railcar 2 from the flatbed 14 to a destination rail track 4 (e.g., by pulling railcar 2 off of flatbed 14)

In one or more arrangements, the flatbed 14 has a pivot point located such that the flatbed 14 is moved from a tilted position by way of gravity to a horizontal position as a railcar 2 is moved forward fully onto the flatbed. However, the arrangements are not so limited. Rather, it is contemplated that in some various arrangements, system 10 may be configured to facilitate tilting of the flatbed 14 using various means or methods including but not limited to, for example, movement by gravity and center of balance by positioning of the railcar 2, relocation of the pivot point relative to the flatbed 14, and/or other mechanized movement of the flatbed (e.g., hydraulics, motors, or other method or means to facilitate movement).

In one or more arrangements, wheel assembly 18 is operably connected with flatbed 14 by one or more tracks or rails positioned on an underside of flatbed 14 so as to permit wheel assembly 18 to be moved forward and/or rearward relative to flatbed 14, and thereby adjust the pivot point of the flatbed 14. In one or more arrangements, system 10 includes one or more hydraulic cylinders configured to move wheel assembly 18 forward and/or rearward relative to flatbed 14. However, the arrangements are not so limited. Rather, it is contemplated that in some various arrangements, system 10 may be configured to use various different means and/or methods to facilitate movement of wheel assembly 18 including but not limited to, for example (winches, pulleys, jacks, hydraulics, and/or any other method or means suitable to push, pull and/or otherwise move wheel assembly 18 relative to flatbed.

In one or more arrangements, system 10 includes an improved hydraulic system to facilitate movement of various components for loading and/or unloading of railcars 2 (e.g., tilting of the flatbed, movement of a railcar 2 between a set of track rails 4 and the track assembly 16 of the flatbed, and/or movement of other components of system 10. In one or more arrangements, the hydraulic system includes an oil cooler to prevent overheating under strain. For example, commercial hydraulic systems may only be capable of performing a few cycles a day. By implementing oil cooling, the improved hydraulic system may perform multiple load/unload cycles an hour.

### In Operation

In operation, in one or more arrangements, system 10 can be utilized to easily and efficiently transport railcars 2 without dedicated rail infrastructure (e.g., tracks, switches, etc) and permit railcars 2 to be moved to remote storage locations to permit users to reduce storage expense while also increasing accessibility of railcars 2 and decreasing storage/retrieval time. As one example storage application, in one or more arrangements, system 10 may be utilized with compact storage rail can be installed on virtually any flat ground, onsite and/or offsite, without expensive switching equipment. Railcars 2 can be stored and retrieved in hours, not days or weeks, saving money and virtually eliminating logistic and scheduling issues. Moreover, railcars 2 are easily accessible on demand. In one or more arrangements, overhead storage costs may further be reduced by storing railcars 2 on lightweight track 4 since the track is not needed for transportation.

### Control System 100

In one or more arrangements, system includes a control system 100 to facilitate operation of various powered components of system (e.g., winches, hydraulics, and/or other mechanized components used to facilitate loading and/or unloading of railcars 2. Control system 100 is formed of any suitable size, shape, design and is configured to control operation of various components of system 10 for example, in response to input from user interface 106. In the arrangement shown, as one example implementation, control system 100 includes a communication circuit 102, a processing circuit 103, and a memory 104 having software code 105 or instructions that facilitates the operation of system 100.

Processing circuit 103 may be any computing device that receives and processes information and outputs commands according to software code 105 stored in memory 104. For example, in some various arrangements, processing circuit 103 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 104. Memory 104 may be any form of information storage such as flash memory, ram memory, dram memory, a hard drive, or any other form of memory.

Processing circuit 103 and memory 104 may be formed of a single combined unit. Alternatively, processing circuit 103 and memory 104 may be formed of separate but electrically connected components. Alternatively, processing circuit 103 and memory 104 may each be formed of multiple separate but communicatively connected components.

Software code 105 is any form of instructions or rules that direct processing circuit 103 how to receive, interpret and respond to information to operate as described herein. Software code 105 or instructions is stored in memory 104 and accessible to processing circuit 103. As an illustrative example, in one or more arrangements, software code 105 or instructions may configure processing circuit 103 control system 100 to monitor user interface 106 and/or various sensors (not shown) of system 100 and perform various preprogramed actions in response to signals from user interface 106 and/or such sensors satisfying one or more trigger conditions.

As some illustrative examples, some actions that may be initiated by control system 100 in response to signals from sensors and/or user input from user interface 106 include but are not limited to, for example, tilting flatbed and/or controlling a winch to facilitate loading and/or unloading of a railcar 2.

Communication circuit 102 is formed of any suitable size, shape, design, technology, and in any arrangement and is configured to facilitate communication with devices to be controlled, monitored, and/or alerted by control system 300. In one or more arrangements, as one example, communication circuit 102 is a includes a transmitter (for one-way communication) or transceiver (for two-way communication). In various arrangements, communication circuit 102 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### User Interface 106

User interface 106 is formed of any suitable size, shape, design, technology, and in any arrangement and is configured to facilitate user control and/or adjustment of various components of system 10. In one or more arrangements, as one example, user interface 106 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 106 includes a display (not shown). Display is formed of any suitable size, shape, design, technology, and in any arrangement and is configured to facilitate display information of settings, sensor readings, time elapsed, and/or other information pertaining to operation or system 10.

From the above discussion it will be appreciated that the system improves upon the state of the art. More specifically, and without limitation, it will be appreciated that in one or more arrangements a system is provided for transportation and storage of railcars: that assists in the loading and transportation of railcars between rail systems; that assists in the loading and transportation of railcars by truck; that facilitates storing cars on tracks that are not FRA certified and do not have switches joining them; that is efficient; that is affordable; that is easy to use; that can relocate railcars to remote storage facilities; that is robust; that is durable; that has a long useful life; that works effectively, and/or that is high quality. These and other objects, features, or advantages of the disclosure will become apparent from the specification, figures and claims.

It will be appreciated by those skilled in the art that other various modifications could be made to the device without parting from the spirit and scope of this disclosure. All such modifications and changes fall within the scope of the claims and are intended to be covered thereby.

What is claimed is:

1. A system for transportation of a railcar, comprising:
a trailer;
the trailer having a flatbed;
wherein the flatbed is configured to move between a tilted position and a horizontal position;
wherein the flatbed has a track assembly that when the flatbed is tilted and the track assembly is aligned with a set of rail tracks, a railcar may be loaded by rolling the railcar from the rail tracks onto the track assembly of the flatbed; and
an alignment device operably connected to the flatbed and configured to automatically align the track assembly of the flatbed with the set of rail tracks as the flatbed is tilted downward towards the track.

2. The system of claim 1, wherein the alignment device as a pair of opposing sidewalls oriented in at an angle with respect to each other when viewed from above.

3. The system of claim 1, wherein the alignment device is operably connected to a rearward end of the flatbed;
wherein the alignment device as a pair of opposing sidewalls mounted to an underside of the flatbed;
wherein the opposing sidewalls extend from a forward end where the sidewall are aligned with the track assembly, to a rearward end;
wherein the opposing sidewalls are angled so the opposing sidewalls move further away from one another as the opposing sidewalls extend from the forward end to the rearward end.

4. The system of claim 1, wherein the alignment device is positioned to facilitate alignment of the track assembly with a first rail track;
wherein the system further includes a second alignment device positioned to facilitate alignment of the track assembly with a second rail track.

5. The system of claim 1, further comprising a wheel assembly;
wherein the wheel assembly is movable forward and rearward relative to the flatbed.

6. The system of claim 1, further comprising a wheel assembly;
wherein the wheel assembly is movable forward and v relative to the flatbed;
wherein the movement of the wheel assembly forward and rearward relative to the flatbed adjusts the pivot point for the flatbed when tilted.

7. The system of claim 1, further comprising:
a wheel assembly;
wherein the wheel assembly is movable forward and rearward relative to the flatbed;
a hydraulic system;
wherein the hydraulic system is configured to move the wheel assembly forward and rearward relative to the flatbed.

8. The system of claim 1, further comprising:
a wheel assembly;
wherein the wheel assembly is movable forward and rearward relative to the flatbed;
a hydraulic system;
wherein the hydraulic system is configured to move the wheel assembly forward and rearward relative to the flatbed;
wherein the hydraulic system includes a cooler configured to cool the hydraulic system.

9. The system of claim 1, wherein the system is configured to facilitate movement of railcars from and onto non-FRA certified track.
